(19) United States
(12) Patent Application Publication
(10) Pub. No.: US 2023/0034206 A1
(43) Pub. Date: Feb. 2, 2023

(54) MULTI-CARTRIDGE AIR FILTRATION UNIT

(71) Applicant: Blade Filters Inc., Markham (CA)

(72) Inventor: Joseph Thomas Fida, Markham (CA)

(21) Appl. No.: 17/757,912

(22) PCT Filed: Dec. 23, 2019
(86) PCT No.: PCT/CA2019/051902

§ 371 Date: Jun. 23, 2022

(51) Int. Cl. B01D 46/24; B01D 46/00; B01D 46/56

(52) U.S. Cl. CPC B01D 46/2414; B01D 46/0002; B01D 46/56; B01D 2271/027

(57) ABSTRACT

A filter assembly comprising: an inner cartridge; an outer cartridge; a cartridge flange end cap comprising a base peripheral flange and centrally-located cylindrical raised base; a cartridge flange top cap comprising a ring portion defining an opening, a peripheral flange; whereby one end of the inner cartridge is held around the centrally-located cylindrical raised base and other end of the inner cartridge is received by the opening in the cartridge flange top cap; and one end of the outer cartridge engages an inner wall of the base peripheral flange and other end of the outer cartridge engages an inner wall of the peripheral flange.

### FIELD OF THE INVENTION

The present invention relates to air filtration units, more particularly it relates to air filtration units having multi-piece media cartridges.

### DESCRIPTION OF THE RELATED ART

Air filtration units are used in various applications, ranging from small appliances, to automobiles, to heating and air conditioning systems. In general, an air filtration unit draws or presses air through a filtration media in order to remove contaminants from the air stream.

In hydroponic and greenhouse facilities, air filters are used to reduce odors and control emissions from growing operations. Ambient air is circulated through activated charcoal in the filter and returned to the greenhouse or vented to the environment.

In a greenhouse or hydroponic setting, air is typically drawn into an air filtration unit through a “pre-filter” supported by an external mesh. The incoming air moves through a layer of activated charcoal and passes to a central chamber, where the purified air is drawn off for recirculation or venting to the environment. In other situations, air is drawn from the environment into the greenhouse via the filtration unit. The filtration unit must be frequently replaced as the filter media is used up or becomes blocked with particulate matter. In many applications, the filtration unit is positioned overhead, making replacement more difficult.

Conventional filtration units are of unitary construction. Expired filters must therefore be disconnected from the ventilation system when being replaced. This often requires a time and labour-intensive process of detaching and reattaching the filter to the ventilation system using fasteners, clamps, duct tape, or the like. This is particularly difficult when the filtration unit is located in a hard to reach area, such as an overhead installation. The inability to recycle or re-use portions of the filtration unit also adds to the material cost of maintaining such filters. The time, material, and labour costs for the user are therefore significant.

It is an object of the present invention to mitigate or obviate at least one of the above-mentioned disadvantages.

### SUMMARY OF THE INVENTION

In one of its aspects, there is provided an air filtration unit comprising:

a lower cartridge assembly and an upper cartridge assembly adjacent to each other, the lower cartridge assembly comprising:

a lower cartridge inner portion defining a lower central air passage extending along a longitudinal axis of the filtration unit;

a lower cartridge outer portion surrounding the lower cartridge inner portion defining a lower chamber therebetween;

a lower cartridge flange end cap for receiving one end of each of the lower cartridge inner portion cartridge and the lower cartridge outer portion to close off one end of the lower central air passage in the lower cartridge assembly,

a lower cartridge flange top cap comprising a lower ring portion defining a lower opening, and whereby other end of the lower cartridge outer portion engages the lower cartridge flange top cap and other end of the lower cartridge inner portion is received by the lower opening in the cartridge flange top cap;

the upper cartridge assembly comprising:
an upper cartridge inner portion defining an upper central air passage extending along the longitudinal axis of the filtration unit;
an upper cartridge outer portion surrounding the upper cartridge inner portion defining an upper chamber therebetween;
an upper cartridge flange end cap comprising an upper ring portion defining an upper opening, and whereby one end of the upper cartridge outer portion engages the upper cartridge flange end cap and one end of the upper cartridge inner portion sits inside upper ring portion and is centrally secured by engaging an outer flange wall surrounding the upper opening;
an upper cartridge flange top cap comprising an upper top ring portion defining an upper top opening, and whereby other end of the upper cartridge outer portion engages the upper cartridge flange end cap and other end of the upper cartridge inner portion is received by the upper top opening in the cartridge flange top cap;
a housing supporting the first cartridge assembly and a second cartridge

assembly, the housing comprising a base, side panels, a housing cap and supports connecting the base and the housing cap, wherein the housing cap comprises a flanged opening in communication with the upper and lower central air passages.

In another aspect, there is provided a filter assembly comprising:

an inner cartridge;

an outer cartridge;

a cartridge flange end cap comprising a base peripheral flange and centrally-located cylindrical raised base;

a cartridge flange top cap comprising a ring portion defining an opening, a peripheral flange;

whereby one end of the inner cartridge is held around the centrally-located cylindrical raised base and other end of the inner cartridge is received by the opening in the cartridge flange top cap; and one end of the outer cartridge engages an inner wall of the base peripheral flange and other end of the outer cartridge engages an inner wall of the peripheral flange.

Advantageously, the housing comprises at least one removable panel and the base includes adjustable supports to enhance stability of the unit when placed upright. In addition, the base includes a raised cylindrical wall that helps centering the lower cartridge assembly within the housing, and hence also the upper cartridge assembly. Furthermore, the unit may comprise a plurality of filter cartridge assemblies, which reduce issues when handling the units because of the weight associated.

### BRIEF DESCRIPTION OF THE DRAWINGS

Several exemplary embodiments of the present invention will now be described, by way of example only, with reference to the appended drawings in which:

FIG. 1 shows an exploded view of a multi-piece air filtration unit;

FIG. 2 shows a housing for the air filtration unit of FIG. 1;

FIG. 3 shows a first filter assembly and second filter assembly; and

FIG. 4 shows another view of the multi-piece air filtration unit.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

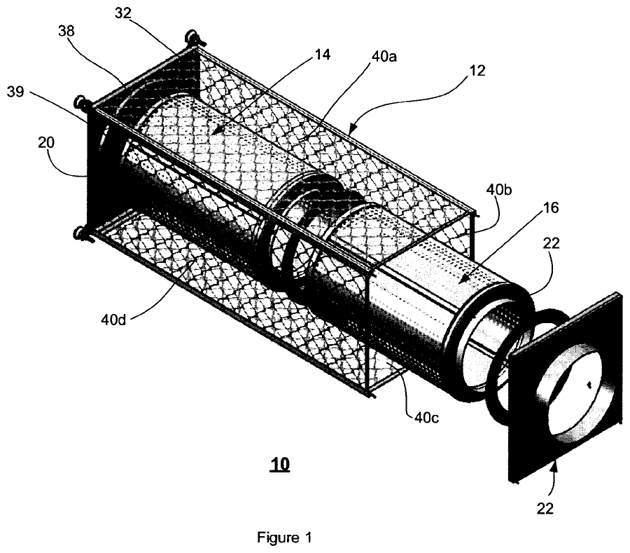

FIG. 1 shows an exploded view of a multi-piece air filtration unit generally identified by reference numeral 10, within housing 12, in an exemplary embodiment. Multi-piece air filtration unit 10 comprises first filter assembly 14 and second filter assembly 16.

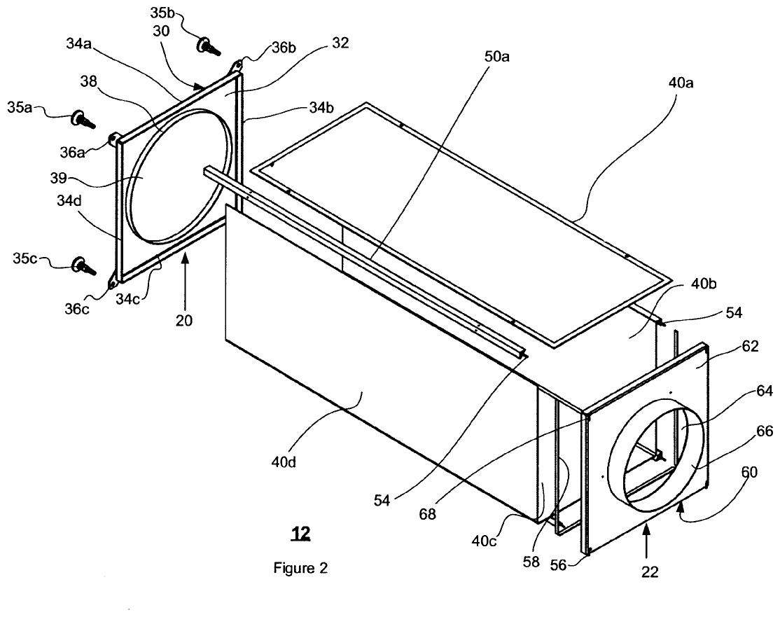

In more detail, as shown in FIG. 2, housing 12 comprises first end cap 20 which receives first filter assembly 14 and second end cap 22 which receives second filter assembly 16. First end cap 20 is generally rectangularly-shaped and comprises outer surface 30 and opposed inner surface 32 with side edges 34a-34d having fastener receiving means 35a-35d at each corner for receiving adjustable mounts 36a-36d projecting away from outer surface 30. Accordingly, filtration unit 10 may be supported by a horizontal surface, such as a floor or other ground structure. Alternatively, filtration unit 10 may be mounted on a wall or ceiling. Inner surface 32 includes circular collar 38 depending therefrom and defining void 39 which receives and centers first filter assembly 14 within housing 12.

Positioned between first end cap 20 and second end cap 22 are covers 40a-40d which abut each other to form rectangular housing 12. Covers 40a-40d are connected to each other at corners by corner bracket assemblies 50a-50d such that cover 40a-40d is received between corner bracket assembly 50a and 50b; 50b and 50c, 50c and 50d; and 50d and 50a, to form cavity 54. One end of corner bracket assembly 50a-50d includes screw means 54 which are received by complimentary orifices 56 on second end cap 22, as shown in FIG. 2. Support beam 58 holds covers 40a-40d in place and is received by second end cap 22 comprising inner surface 60 and outer surface 62 with circular opening 64 having flange lip 66 depending therefrom. With each of screw means 54 received by orifices 56 of second end cap 22, and fastener 68, such as a wingnut, is screwed onto screw means 54 to securely hold second end cap 22 to corner bracket assembly 50a-50d.

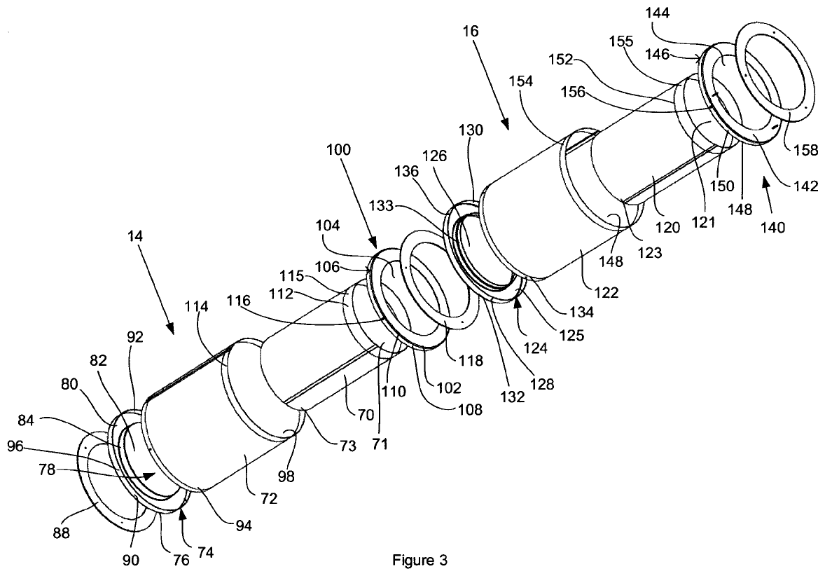

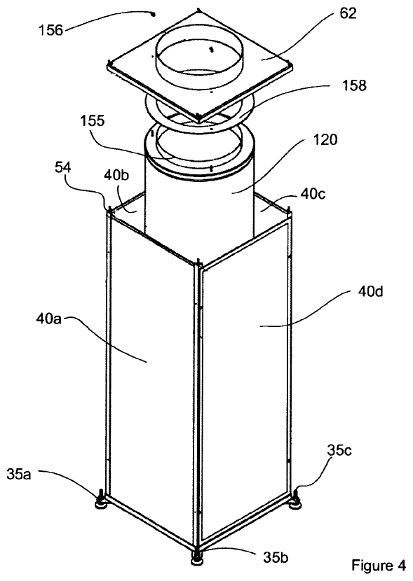

Now turning to FIGS. 3 and 4, there is shown first filter assembly 14 and second filter assembly 16 in greater detail. First filter assembly 14 comprises lower cartridge inner portion 70 having first central air passage 71 and lower cartridge outer portion 72. One end 73 of lower cartridge inner portion 70 is received by lower cartridge flange end cap 74 comprising a base peripheral flange 76 and centrally-located cylindrical raised base 78 such that circular channel 80 is defined therebetween. Centrally-located cylindrical raised base 78 is disc-shaped and includes top surface 82 and edge wall 84. The diameter of lower cartridge inner portion 70 is dimensioned such that one end 73 of lower cartridge inner portion 70 engages edge wall 84 of centrally-located cylindrical raised base 78 to securely hold lower cartridge inner portion 70 in place. Lower cartridge gasket 88 is sandwiched between lower cartridge flange end cap 74 and first end cap 20.

Base peripheral flange 76 comprises outer wall 90 and inner wall 92. Lower cartridge flange end cap 74 receives first filter assembly 14 such that one end 94 of lower cartridge outer portion 72 engages inner wall 92 and is securely attached thereto by fasteners 96. Accordingly, cavity 98 defined between lower cartridge inner portion 70 and lower cartridge outer portion 72 receives filter media 99 (not shown). Lower cartridge flange top cap 100 comprises ring portion 102 defining opening 104, with raised middle peripheral flange 106 having inner wall 108 and outer wall 110. Other end 112 of lower cartridge inner portion 70 is received in opening 104 of lower cartridge flange top cap 100, and other end 114 of lower cartridge outer portion 72 is engages inner wall 108. Portion 115 of other end 112 of lower cartridge inner portion 70 extends beyond lower cartridge flange top cap 100. Fasteners 116 securely hold lower cartridge outer portion 72 and lower cartridge flange top cap 100 together. Middle cartridge gasket 118 abuts ring portion 102 and engages by upper cartridge flange end cap 124, as will be described below in more detail.

Similar to first filter assembly 14, second filter assembly 16 comprises upper cartridge inner portion 120 having second central air passage 121, and upper cartridge outer portion 122. One end 123 of upper cartridge inner portion 120 is received by upper cartridge flange end cap 124 comprising ring portion 125 defining opening 126. Ring portion 125 comprises raised peripheral flange 128 having inner wall 130 and outer wall 132. Accordingly, one end 123 of upper cartridge inner portion 120 sits inside the ring portion 125 and is centrally secured by engaging outer flange wall 133 surrounding opening 126 such that second central air passage 121 is in communication with first central air passage 71. Upper cartridge outer portion 122 is received by upper cartridge flange end cap 124 such that one end 134 of upper cartridge outer portion 122 engages inner wall 130 and is securely attached thereto by fasteners 136.

Upper cartridge flange top cap 140 comprises ring portion 142 defining opening 144, with raised middle peripheral flange 146 having inner wall 148 and outer wall 150. Other end 152 of upper cartridge inner portion 120 is received in opening 144 of upper cartridge flange top cap 140, and other end 154 of upper cartridge outer portion 122 is engages inner wall 148. Portion 155 of other end 152 of upper cartridge inner portion 120 extends beyond upper cartridge flange top cap 140. Fasteners 156 securely hold upper cartridge outer portion 122 and upper cartridge flange end cap 140 together. Upper cartridge gasket 158 is sandwiched between ring portion 142 and second end cap 22. Accordingly, opening 64 of second end cap 22 is in communication with second central air passage 121 and first central air passage 71.

In one exemplary implementation, cartridge 120 is substantially cylindrical and is manufactured from perforated cold rolled steel.

In one exemplary implementation, housing 12 includes another shape other than rectangular, and constructed of perforated stainless steel.

In one exemplary implementation, lower cartridge flange end cap 74 and first end cap 20 are in direct contact with each other; and lower cartridge flange top cap 100 and upper cartridge flange end cap 124 are in direct contact with each other; and upper cartridge flange top cap 140 and second end cap 22 are in direct contact with each other.

The exemplary embodiments shown in FIGS. 1 to 4 may be manufactured from sheet metal and/or perforated sheet metal that is spot welded as necessary. Various other suitable materials and construction methods would be readily apparent to the person of skill having regard to the present description and are contemplated herein. In particular, it may be possible to replace some or all components of the invention with plastics, to reduce material costs. For example, it may be possible to manufacture the multi-piece air filtration unit 10 comprises first filter assembly 14 and second filter assembly 16 from injection moulded plastic, to reduce material costs.

The air filtration unit 10 can be used in various applications where there is a need to filter air. In one exemplary implementation, the filtration unit 10 is used in a greenhouse or hydroponic setting and may include, but are not limited to, activated charcoal filtration media to control odours or other emissions.

In one exemplary implementation, the air flows through the flanged opening to the upper central air passage and the lower central air passage, through the lower cartridge inner portion, the lower cartridge outer portion, the filtration media, the upper cartridge inner portion and the upper cartridge outer portion. Alternatively, the airflow is reversed.

The embodiments of the present disclosure are intended to be examples only. Those of skill in the art may effect alterations, modifications and variations to the particular embodiments without departing from the intended scope of the present application.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Thus, the preceding detailed description is presented for purposes of illustration only and not of limitation, and the scope of the invention is defined by the preceding description, and with respect to the attached claims.

What is claimed is:

1. An air filtration unit comprising:
a lower cartridge assembly and an upper cartridge assembly adjacent to each other, the lower cartridge assembly comprising:
a lower cartridge inner portion defining a lower central air passage extending along a longitudinal axis of the filtration unit;
a lower cartridge outer portion surrounding the lower cartridge inner portion defining a lower chamber therebetween;
a lower cartridge flange end cap for receiving one end of each of the lower cartridge inner portion cartridge and the lower cartridge outer portion to close off one end of the lower central air passage in the lower cartridge assembly,
a lower cartridge flange top cap comprising a lower ring portion defining a lower opening, and whereby other end of the lower cartridge outer portion engages the lower cartridge flange top cap and other end of the lower cartridge inner portion is received by the lower opening in the cartridge flange top cap;
the upper cartridge assembly comprising:
an upper cartridge inner portion defining an upper central air passage extending along the longitudinal axis of the filtration unit;
an upper cartridge outer portion surrounding the upper cartridge inner portion defining an upper chamber therebetween;
an upper cartridge flange end cap comprising an upper ring portion defining an upper opening, and whereby one end of the upper cartridge outer portion engages the upper cartridge flange end cap and one end of the upper cartridge inner portion sits inside upper ring portion and is centrally secured by engaging an outer flange wall surrounding the upper opening;
an upper cartridge flange top cap comprising an upper top ring portion defining an upper top opening, and whereby other end of the upper cartridge outer portion engages the upper cartridge flange end cap and other end of the upper cartridge inner portion is received by the upper top opening in the cartridge flange top cap;
a housing supporting the lower cartridge assembly and the upper cartridge assembly, the housing comprising a base, side panels, a housing cap and supports connecting the base and the housing cap, wherein the housing cap comprises a flanged opening in communication with the upper and lower central air passages.

2. The air filtration unit of claim 2, wherein the side panels are positioned between the base and the housing cap.

3. The air filtration unit of claim 1, wherein the lower cartridge flange end cap comprises a centrally disposed raised portion for receiving and centering the lower cartridge inner portion.

4. The air filtration unit of claim 3, wherein the lower cartridge flange end cap comprises a peripheral flange, wherein the one end of the lower cartridge outer portion engages the peripheral flange.

5. The air filtration unit of claim 1, wherein a middle cartridge gasket disposed between the upper cartridge flange end cap and the lower cartridge flange top cap.

6. The air filtration unit of claim 1, further comprising a lower cartridge gasket disposed between the base and the lower cartridge flange end cap.

7. The air filtration unit of claim 1, further comprising an upper cartridge gasket disposed between the housing cap and the upper cartridge flange top cap.

8. The air filtration unit of claim 1, further comprising fasteners for securing the lower cartridge flange end cap and the lower cartridge flange top cap to the lower cartridge outer portion.

9. The air filtration unit of claim 1, further comprising fasteners for securing the upper cartridge flange end cap and the upper cartridge flange top cap to the upper cartridge outer portion.

10. The air filtration unit of claim 1, wherein the lower cartridge outer portion, the lower cartridge inner portion, the upper cartridge outer portion, and the upper cartridge inner portion comprise perforated walls.

11. The air filtration unit of claim 1, wherein the side panels comprise an air permeable portion.

12. The air filtration unit of claim 1, wherein at least one of the side panels is removably attached.

13. The air filtration unit of claim 1, wherein the base comprises a circular collar defining a void for receiving and centering the lower cartridge assembly within the housing.

14. The air filtration unit of claim 12, wherein the base includes adjustable supports to enhance stability of the unit when placed upright.

15. The air filtration unit of claim 1, wherein the housing is dimensioned to house a plurality of lower cartridge assemblies and upper cartridge assemblies.

16. The air filtration unit of claim 1, wherein at least one filtration media disposed in the lower chamber and the upper chamber.

17. The air filtration unit of claim 16, wherein the lower cartridge assembly and the upper cartridge assembly are reusable.

18. The air filtration unit of claim 1, wherein air flows through the flanged opening to the upper central air passage and the lower central air passage, through the lower cartridge inner portion, the lower cartridge outer portion, the least one filtration media, the upper cartridge inner portion and the upper cartridge outer portion.

19. The air filtration unit of claim 1, wherein air flows through the lower cartridge inner portion, the lower cartridge outer portion, the least one filtration media, the upper cartridge inner portion and the upper cartridge outer portion, to the upper central air passage and the lower central air passage and through the flanged opening.

20. The air filtration unit of claim 1, comprising a plurality of at least one the lower cartridge assembly and the upper cartridge assembly stacked together and supported within the housing.

21. A filter assembly comprising:
an inner cartridge;
an outer cartridge;
a cartridge flange end cap comprising a base peripheral flange and centrally-located cylindrical raised base;
a cartridge flange top cap comprising a ring portion defining an opening, a peripheral flange;
whereby one end of the inner cartridge is held around the centrally-located cylindrical raised base and other end of the inner cartridge is received by the opening in the cartridge flange top cap; and one end of the outer cartridge engages an inner wall of the base peripheral flange and other end of the outer cartridge engages an inner wall of the peripheral flange.

22. The filter assembly of claim 21, wherein a cavity is defined between the inner cartridge and the outer cartridge.

23. The filter assembly of claim 22, further comprising fasteners for securing the cartridge flange end cap and the cartridge flange top cap to the outer cartridge.

24. The filter assembly of claim 21, further comprising filtration media disposed within the cavity.

25. The filter assembly of claim 24, wherein at least one of the cartridge flange top cap and the cartridge flange end cap receives another filter assembly to form a multi-unit filter assembly.

26. The filter assembly of claim 25, wherein the multi-unit filter assembly is supported within a housing.
